(19) United States
(12) Patent Application Publication
(10) Pub. No.: US 2002/0123256 A1
(43) Pub. Date: Sep. 5, 2002

(54) Shuttle plate connector

(76) Inventor: Benjamin P. Brickett, Eliot, ME (US)

Correspondence Address: DEVINE, MILLIMET & BRANCH, P.A., 111 AMHERST STREET, BOX 719, MANCHESTER, NH, 03105, US

(21) Appl. No.: 09/798,015

(22) Filed: Mar. 1, 2001

(51) Int. Cl. H01R 13/44

(52) U.S. Cl. 439/140

(57) ABSTRACT

A mateable shuttle plate connector used for hostile environment electrical connections. The shuttle plate connector has a female connector, filled with a pressure-equalizing medium and has a sealed end and a receiving end. The shuttle plate connector also has a male connector, also filled with a pressure-equalizing medium, and has a sealed end and a mating end. A sliding seal plate is located in the female connector to seal the receiving end of the connector. The seal plate is spring-loaded to allow it to slide out of position when forced and return to the original position when the force is removed. The female connector has contains electrical contacts on its inner walls. The male connector has a conduit plate containing electrical contacts. When the conduit plate within the male connector slides into the female connector, the seal plate is slid out of position and the female and male electrical contacts meet to close a circuit.

### FIELD OF THE INVENTION

The invention relates generally to mateable connections for use in hostile environments. More specifically the invention relates to mateable connectors for use in environments having pressure extremes, such as extremely high-pressure undersea environments, or vacuum conditions found in outer space, or in potentially explosive or volatile environments. The invention may be used in any environment where there is high volatility or sensitivity of the connected medium to external conditions. The invention is also used at normal atmospheric pressures without pressure compensation. Most specifically the invention relates to in situ mateable pressure compensatable electrical, optical, hybrid electro-optical, hydraulic, acoustic or gas connections.

### BACKGROUND OF THE INVENTION

There are many types of connectors for making connections in hostile environments, such as underwater. The majority of these known connections must be made in a controlled environment prior to exposure to the hostile environment. With the advent of rapid growth in oceanographic exploration, it has become necessary to provide underwater electrical, optical and hydraulic equipment, which is reliable, relatively inexpensive and easy to work with while in the hostile environment. Underwater circuit connectors for interconnecting cables and hoses are an essential component in many underwater systems such as offshore oil drilling platform systems and defense sector applications. The reliability of these connectors is critical because a failed connector can cause serious adverse effects on the operation of, for example a sub-sea system. Common causes of connector failure include corrosion due to cathodic effects, the salt water environment, the inability to isolate the circuit contacts from the environments, designs which allow tolerances of multiple dimensions to become additive causing the connector to exceed specification or designs, all of which present potential problems for a diver, or automated means, attempting assembly or decoupling of a connector. There have been improvements in corrosion resistance of connectors as the art has developed but there is still a need for a more easily assembled connector that will not fatigue and which has a simple design that is inexpensive to manufacture. Connectors in the past have relied mainly on an interference or compression of resilient members for sealing of internal components. Past connectors also have been limited in the number of circuits, which can be utilized in the connector.

One category of connectors includes connectors intended for sub-sea mating and demating and offers the ability to mate and demate circuits underwater. Such underwater connectors typically comprise a receptacle or female connector connected to one cable end and a plug or male connector connected to the other cable end and designed for mating engagement with the receptacle. These parts must be designed such that they can be connected underwater, and can be repeatedly mated and demated underwater. In one type of underwater connector, the circuits are isolated from the environment by having the receptacle socket filled with dielectric fluid or a semi-mobile compound. The female portion (or receptacle) contains electrical, optical or other contacts within a sealed hermetic chamber. The male portion (or plug) has one or more contact probes exposed to the environment prior to engagement. The probe(s) enter the sealed hermetic chamber and contact the female contact elements in the sealed receptacle chamber to make the connection.

Historically these types of connectors are precision machined mechanical devices which utilize complex sealing mechanisms to contain the protective medium yet allow mating of the connector circuits. Costs associated with the manufacture of these devices are substantial, and have typically resulted in selling prices of such magnitude that the utilization of these products has been limited to only the most critical of systems.

The major problem with past underwater connectors, which has resulted in the expensive, complicated sealing mechanisms, has been ensuring that seawater cannot enter the connection chamber and that fluid in the connection chambers can not leak out, especially over time. The longevity of many current systems is questionable due to the “cold set” of seals such that the seals become inflexible due to loss of memory and are no longer able to function properly.

Several general types of different sealing mechanisms have been devised in the past for sealing the connectors as the connection is made. One such sealing mechanism has an opening into the mating/connection chamber which comprises an elastomeric tubular entrance surrounded by an elastomeric sphincter that pinches the entrance closed upon itself, in the unmated condition. In the mated condition, the sphincter pinches against the entering probe. Although this type of seal is successful in some cases, it does have some drawbacks. One drawback is that seals of this type do not work well in all conditions. Another drawback is that such seals will lose their “memory” after they have been mated and demated a number of times, and will then fail to close quickly enough to isolate the chamber from the surrounding environment.

There are various other means for assuring isolation of the contacts from the environment. Some existing means for isolation, used in various different connectors, include rotating seal valves, tubular socket contacts in the receptacle unit, and spring-biased pistons which are urged into sealing engagement with the open ends of the sockets. In the piston arrangement, as the plug and receptacle units are mated, pins on the plug portion urge the pistons back past contact bands in the sockets, so that electrical contact is made. However, this type of arrangement cannot be used in an optical connector since the optical contacts must be able to engage axially for practical purposes. Multiple return springs add considerable insertion force to the mating of the connector halves.

To date, the known mechanisms for providing optical and electrical connections in a hostile environment are not completely effective. Additionally, the optical connectors available are expensive, and generally require complicated means for terminating the connector elements to the transmission cables they are intended to connect. The presently known connectors can not provide an inexpensive connector for making reliable and repeatable optical, electrical and other connections in hostile environments such as great ocean depths, outer space, or outdoor environments.

A subcategory of connectors intended for sub-sea mating and demating, includes connectors that are fluid filled and pressure balanced. In general, fluid filled connectors have a closed chamber wherein there is an oil filled chamber with an opening which is sealed by a spring-biased slidable shuttle piston arranged to be pushed back by engagement of a projecting male contact pin with the piston. In the unmated condition, the opening seals against the elongate section of a piston contained within the receptacle socket assembly, and resiliently biased outwardly so as to follow the male probe into the opening as the probe is withdrawn. Either being filled with the piston or with the male probe always seals the opening. By providing a shuttle piston, very little, if any distortion of the opening is required, and the opening can be quite large to permit large pin diameters for heavy current and/or a multi service arrangement such as coaxial connection. The opening of the chamber is closed either by the shuttle piston in the unmated condition of the connector, or by the male contact pin when the male and female parts of the connector are brought together. A seal for the opening is provided in the form of a pair of spaced o-rings for engaging the shuttle piston or the contact pin, depending on which of these extends through the opening.

The intention of the fluid filled connectors is to protect the junctions from the outside environment by enclosing them within a chamber of benign, non-conductive, mobile, dielectric substance such as oil, gel, or grease, from which seawater is excluded. These types of connectors are also spark-proof. They can be mated and demated with the receptacle sockets electrically energized. Any arcing is contained within the oil filled chamber and is partially suppressed by the oil. Therefore these types of connectors could be used in volatile atmospheres without danger of spark-induced explosions. However, many of these connectors are relatively large, and cannot accommodate a large number of electrical contacts, and are limited therefore in their uses. Nor are the pin contacts in the plug of many of these current connectors protected from the environment in the unmated condition, resulting in contact corrosion and failure.

With this arrangement, (having the probe contacts exposed to the atmosphere) there is a risk of deterioration of the seal, which may result in water or contaminants entering the chamber where the electrical connection is made. Thus, there were developed connectors with two chambers, one before or outside of the second, such that if the seal on the first chamber weakened, the seal on the second chamber would still maintain the isolation of the electrical contact from the contaminating environment that penetrated the first chamber.

With interference type seals or o-ring sealing members, as the connectors, mated or unmated, are lowered into the sea and subjected to greater and greater pressures, a differential pressure builds up across the sealing means and eventually the seal may fail and water enter the connectors. In response to this problem there were developed connectors that eliminated differential pressures across the sealing means of the connector. One type of such connector has resiliently deformable conduits which, when subjected to pressure, increase the pressure of the nonconducting fluid within the connector against o-ring seals so that the pressure of the nonconducting fluid within the conduit and the housings equals the pressure of the seawater or other atmosphere external to the housings. Since there is little or no differential pressure across the o-ring seals, seawater will not enter the plug or receptacle housing. Since the conduit is resiliently compressible, as the cable and connector assembly go to greater depths and the sea water pressure against the conduit increases, the conduit compresses, thereby increasing the pressure of the nonconducting fluid so as to prevent seawater from entering into the connector assembly through the o-ring seals.

Also, in many known connectors capable of underwater connection, the power must be turned off when it is desired to break contact of the circuit because if the connections are left powered and unconnected, and seawater enters the connectors, electrolytic action will take place, causing corrosion. Thus some connectors cannot be left in place while disconnected with the power on. This is major drawback for undersea operations.

Connectors typical of the type used for underwater or other extreme applications similar to those with which the present invention is used include those of U.S. Pat. Nos. 4,085,993 and 4,795,359, which disclose connectors for underwater use.

Thus there is the need for electrical, fiber optic, hybrid electro-optical, hydraulic, acoustic, and gas connectors that can be installed relatively easily in the field, yet are reliable, and that can be repeatedly mated and demated in a number of hostile environments such as underwater, outer space or other volatile environments.

Therefore it would be desirable to have a high performance connective device similar in purpose to the currently available connectors, and which could be repeatedly mated and demated in hostile environments, but which could be substantially more cost effective, and which would have a number of uses by being of a simple general design, without complicated mechanical parts that could easily fail, and which would provide flexibility and adaptability of use in many applications.

### SUMMARY OF THE INVENTION

A basic embodiment of the invention is a pressure compensatable mateable and switchable shuttle plate connector for use in harsh environments. The connector has a receptacle half with a plurality of receptacle contacts on at least one of two opposing contact carrier surfaces, and a sliding seal plate attached to a positioning means and which covers the receptacle contacts to protect the receptacle contacts when unmated. The receptacle contacts and sliding seal plate are contained within a chamber in the receptacle half. The sliding seal plate, when the connector is unmated, also seals a receiving opening in the chamber of the receptacle half. There is also a mating half which mates with the receptacle half at the receiving opening, such that a conduit plate contained within the mating half and comprising a plurality of mating contacts on at least one mating surface of a conduit plate is sandwiched between the two opposing contact carrier assemblies. There is a normally closed mating opening for the conduit plate to exit the mating half. Both the receptacle half and the mating half are filled with a nonconductive, lubricating material and sealed against the outside environment when mated and unmated.

The positioning means is a spring in one embodiment, which is compressed as the conduit plate enters the receptacle half at the receiving opening. During unmating, the spring pushes against the sliding seal plate to return the sliding seal plate to its initial position as the conduit plate is withdrawn. Therefore, as the conduit plate is withdrawn the spring automatically returns the sliding seal plate to protect the plurality of receptacle contacts in the receptacle chamber, to ensure that the receptacle contacts are always covered. The positioning means could also involve a latching or lever mechanism to return both the sliding seal plate and the conduit plate to their original, unmated positions. Both the receiving opening and the mating opening are self-sealing and normally closed.

The plurality of receptacle contacts may be disposed on one or both of the two opposing contact carrier surfaces of the receptacle half. The plurality of mating contacts may be disposed on one or both of the two mating surfaces of the conduit plate. The receptacle contacts and the mating contacts may be arranged in a staggered formation such that combinations of circuits may be connected and disconnected based on the position of the conduit plate within the receptacle chamber. The sliding seal plate protects unused receptacle contacts. The chamber of the receptacle half, the body of the mating half, and the sliding seal plate and conduit plate are formed from an insulator material.

Thus the invention provides a pressure compensatable connector for use in harsh environments and which may be fitted with any combination of electrical, optical, light wave, acoustic, gas, or hydraulic connection points.

The connector can be manipulated while exposed to harsh external media that would tend to cause degradation of the transfer or connection medium without protection, and can be operated in extreme ranges of atmospheric or oceanic pressure.

One or more circuit contacts can be made within one protective mated connector housing, and each contact is internally isolated. This high-density arrangement enables the connector to be very compact in size. The invention also comprises a minimum of moving parts, which eases manipulation and maintenance of the invention, and hundreds of matings may be made before service is required. The design allows switching of circuit contacts, while the connector is mated, to engage or disengage certain circuits based on the position of the conduit plate within the receptacle half. The conduit plate may simply be withdrawn or inserted at various distances to separate and disconnect, or connect different circuits.

Electrical circuits usable with the present invention are capable of a wide range of operation, from low power signal to high power of more than 1000 KVA and typically have a resistance of less than 0.01 ohms/circuit. Hydraulic circuits of the present invention are capable of pressures to differentials of more than 200 psig.

Both halves of the connector are capable of long-term submergence, for example in a marine environment, mated or unmated, with power supplied or on. The low stress seals eliminate cold set problems. The connector halves and the mating mechanism are self-cleaning or wiping, allowing operation in silt, sand and explosive environments. The connector requires very low insertion and extraction force, independent of the size or number of contacts on the connector. Thus, the present invention solves the problems and shortcomings of previous harsh environment connectors.

### BRIEF DESCRIPTION OF THE DRAWINGS

FIG. 1 is an angled view, side view, and overhead view of the shuttle plate connector invention unmated with the conduit plate in a mated position.

FIG. 2 is an exploded view of the receptacle half of the shuttle plate connector invention.

FIG. 3 is a side view of a cross sectional slice of the shuttle plate connector invention.

FIG. 4 is an image of the sliding seal plate and positioning means from the receptacle half of the shuttle plate connector invention.

### DETAILED DESCRIPTION OF THE INVENTION

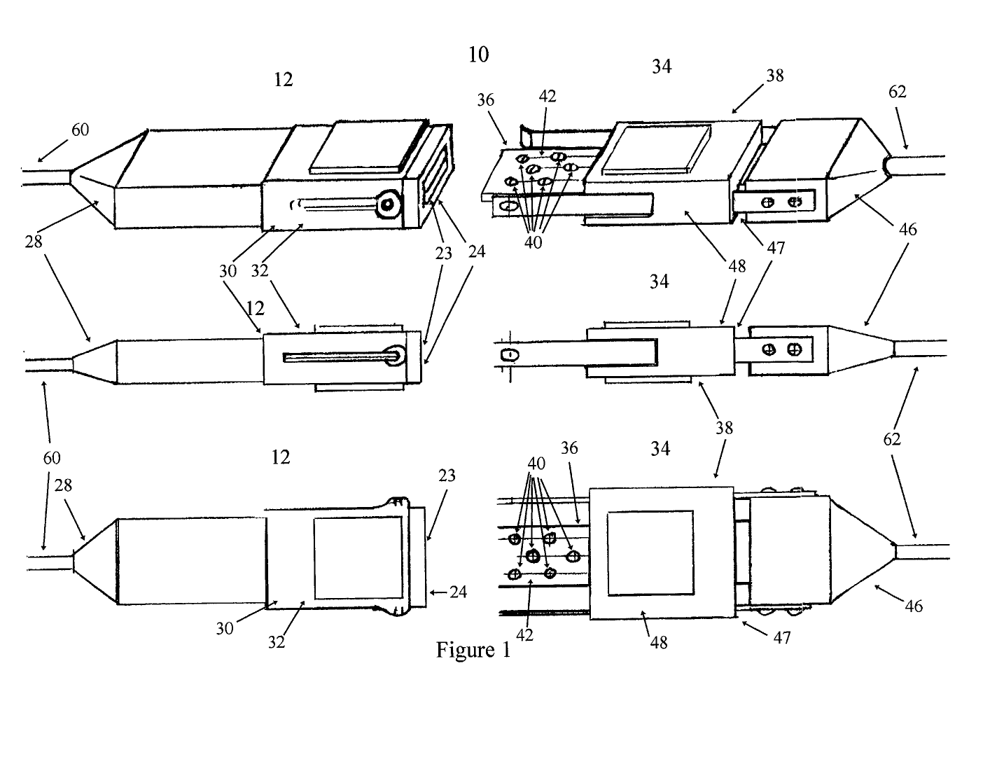

Referring now to the figures, in which like reference numerals refer to like elements throughout, an embodiment of the invention, shown in FIG. 1, is a mateable shuttle plate connector 10 for connecting transmission conduits 60 and 62 in hostile environments. The conduits 60 and 62 will contain the necessary properties for transmitting the matter desired (i.e. insulated copper wire for electrical transmission, fiber optic cable for light transmission, etc.). This connector is capable of connecting transmission conduit 60 and 62 for electrical, optical, light wave, acoustic, gas, hydraulics, or other similar matter in hostile environments. The shuttle plate connector 10 has a receptacle half 12 and a mating half 34.

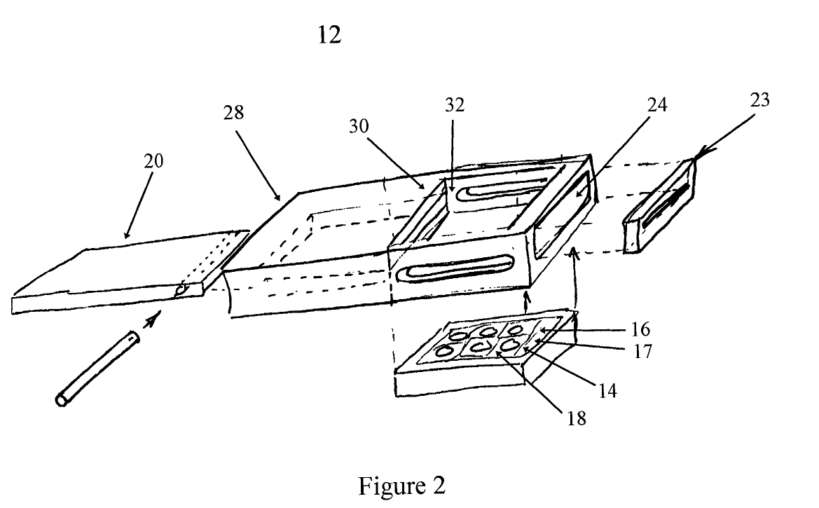

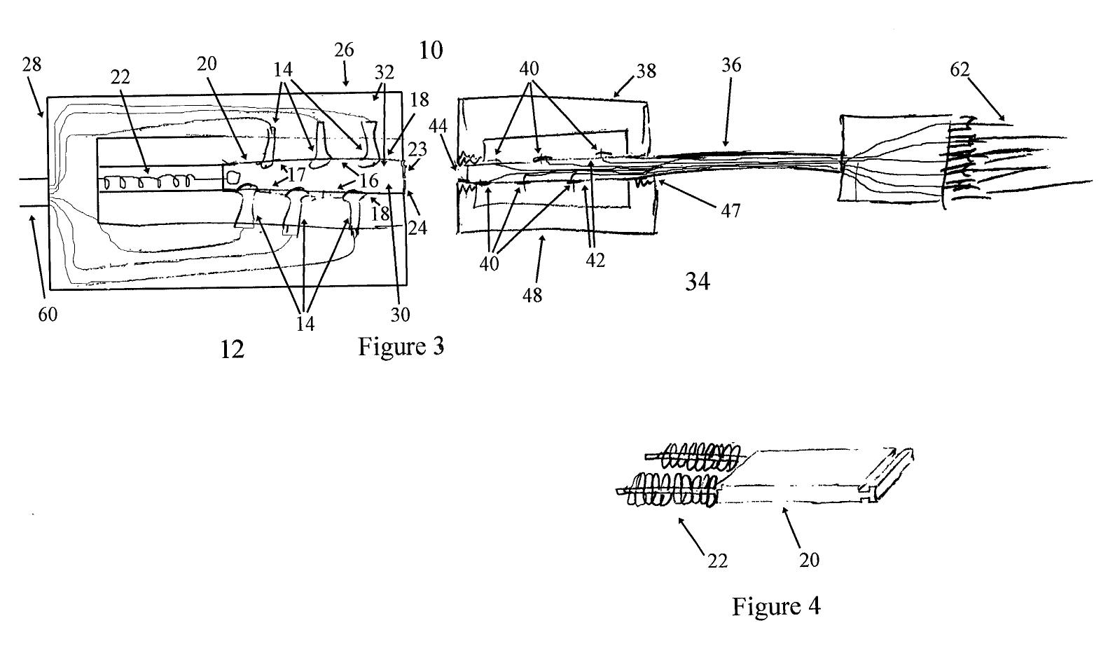

The receptacle half 12, as shown in FIG. 2, has receptacle chamber 30, which has a plurality of receptacle contacts 14 on one or more contact carrier surface 16 of multiple interior surfaces 17, wherein the contacts 14 are surrounded, sealed and isolated from one another by an insulator 18. A sliding seal plate 20 is located at least partially within the receptacle chamber 30 and may be attached to a positioning means 22, as shown in FIGS. 3 and 4, and can be used to cover the plurality of receptacle contacts 14 when unmated to protect them. Sliding seal plate 20, when receptacle half 12 is unmated, also combines with receiving opening seal 23 to seal receiving opening 24 of receptacle half 12. The positioning means 22 is used to return the sliding seal plate 20 to the unmated position for protecting the contacts 14 sealing receiving opening 24.

Receptacle half 12 is sealed against the outside environment at receiving opening 24 and at the axially opposing end 28 of receptacle chamber 30. The receiving opening seal 23 and sealed opposing end 28 may be an interference fit elastomeric wiper, a sliding “Morrison” seal design, or similar seal known in the art. Receptacle contacts 14 and sliding seal plate 20 are contained within receptacle chamber 30. Receptacle chamber 30 may be filled with a pressure-equalizing medium 32, which also provides lubrication for sliding of sliding seal plate 20. Receptacle half 12 further has at least one receptacle conduit 60 connected to at least one receptacle contact 14.

Connector 10 also comprises a mating half 34 which mates with receptacle half 12 at receiving opening 24. A conduit plate 36, formed from nonreactive material, is contained within a storage chamber 48 of mating half 34. Nonreactive material is understood to mean material, which will suffer minimal structural defect from exposure to hostile environments, the pressure-equalizing medium 32, or any matter transmitted through the connector 10. Conduit plate 36 contains a plurality of mating contacts 40 on at least one of the available mating surfaces 42 of conduit plate 36. Contacts 40 are surrounded, sealed and isolated from one another by the non-reactive material of conduit plate 36.

When a receptacle contact 14 is matched against a mating contact 40, transmission of current, light, fluid, or other matter will occur between the receptacle conduit attached to the matched receptacle contact and the mating conduit attached to the matched mating contact. The contact 14 and 40, may be no more than the natural termination of the conduits 60 and 62, so long as when the mating contact 40 and receptacle contact 14 are matched, transmission occurs between conduits 60 and 62.

While conduit plate 36 is shown in the figures to be substantially flat in shape, another embodiment contemplated by the inventor is for the cross-sectional area of conduit plate 36 to be square, triangular, hexagonal, or other configuration instead of the illustrated somewhat two-dimensional appearance. The deeper conduit plate 36 is, the easier it would be to allow 3 or more mating surfaces 42 to be used, as well as enabling use of coaxial cable, fiber optic cable, or other similarly bulky cable to be used with this connector 10. Deeper conduit plates 36 would also be better suited to handling transmission of multiple matter types (such as gas and light).

When unmated, conduit plate 36 seals a normally closed mating opening 44 of storage chamber 48. Storage chamber 48 is also sealed at an end 47 axially opposing mating opening 44. An interference fit elastomeric wiper, sliding “Morrison” seal, or other similar seal design known in the art may seal mating opening 44 and end 47. The cross sectional area of conduit plate 36 is substantially equivalent to that of sliding seal plate 20. Storage chamber 48 may also be filled with pressure equalizing and lubricating medium 32, such that both receptacle half 12 and mating half 34 are protected against the outside environment at all times, whether mated or unmated.

Positioning means 22 may be a spring or other similarly functioning mechanism which is compressed during mating as conduit plate 36 is pushed with an external force, enters receptacle half 12 at receiving opening 24 and pushes against sliding seal plate 20. When mated, conduit plate 36 is sandwiched between multiple interior surfaces 17 of receptacle half 12 inside receptacle chamber 30, with at least one surface being a contact carrier surface 16. Eventually receptacle contacts 14 of receptacle half 12 align with mating contacts 40 of conduit plate 36 to form the necessary circuit connections. The contact points are similar to the design of conventional “circuit board” contact points as may be seen within computer type connections. Thus, the contact configuration is on a horizontal plane, as opposed to a vertical plane as exhibited by many conventional circular connectors, as described in the background. During unmating, positioning means 22 expands as conduit plate 36 is withdrawn, and returns sliding seal plate 20 to its position to cover and protect the plurality of receptacle contacts 14 and to combine with seal 23 to seal receiving opening 24. Thus at no time during mating or unmating are receptacle contacts 14 or mating contacts 40 exposed to the outside environment.

The plurality of receptacle contacts 14 is disposed on at least one contact carrier surface 16 of the multiple interior surfaces 17. Similarly the plurality of mating contacts 40 is disposed on at least one of the multiple available mating surfaces 42 of conduit plate 36. Receptacle contacts 14 and mating contacts 40 may be arranged in any type of formation respective of each other. For instance, by staggering two receptacle contacts 14 to connect with one mating contact 40 at different stages of mating, the mating contact 40 can be switched between different receptacle contacts 14 to serve different purposes. Similarly, using two receptacle contacts 14 and two mating contacts 40, the contacts 14 and 40 may be aligned so that only one of each pairing of contacts 14 and 40 can be connected at one time. The possibilities allow various combinations of circuits to be connected, disconnected, and/or switched based simply on the position of conduit plate 36 within receptacle half 12. The design of connector 10 allows dozens of circuits to be located within a single connector, limited only by the area of the contact carrier surfaces 16 and mating surfaces 42 available. The circuit contacts 14 may be used for electrical, gas, optical, acoustic, hydraulic connections for example and the connections may be easily changed while the connector is deployed and power is on.

Although the present invention has been described with the above-identified embodiments, those skilled in the art will recognize that changes may be made in form and detail of structure and operation without departing from the spirit and scope of the invention.

Accordingly, what is claimed is:

1. A mateable shuttle plate connector for connecting transmission conduits in hostile environments, said connector comprising:
a receptacle half;
a receptacle chamber within the receptacle half, having at least one normally closed receiving opening;
a mating half, mateable to the receptacle half;
a storage chamber within the mating half, having at least one normally closed mating opening;
at least one sliding seal plate in said receptacle chamber, wherein said sliding seal plate seals at least one of said normally closed receiving opening when in a closed position;
at least one contact carrier surface in said receptacle chamber containing at least one receptacle circuit contact;
at least one receptacle conduit connected to at least one of said receptacle circuit contacts;
at least one conduit plate, contained at least partially within said storage chamber;
at least one mating circuit contact disposed on at least one mating surface on one of said conduit plates; and
at least one mating conduit connected to at least one of said mating circuit contacts and extending out of said mating half.

2. The mateable shuttle plate connector of claim 1 further comprising a positioning means for sliding the sliding seal plate into said closed position.

3. The mateable shuttle plate connector of claim 2 wherein said positioning means is a spring which compresses when said conduit plate is slid into said receptacle chamber during mating, and expands as said conduit plate is withdrawn from said receptacle chamber during unmating, thereby returning said sliding seal plate to said closed position covering said plurality of receptacle circuit contacts and sealing said normally closed receiving opening.

4. The mateable shuttle plate connector of claim 1 wherein a plurality of receptacle circuit contacts is disposed on a plurality of contact carrier surfaces of said receptacle half.

5. The mateable shuttle plate connector of claim 1 wherein a plurality of mating circuit contacts is disposed on a plurality of mating surfaces of said conduit plate.

6. The mateable shuttle plate connector of claim 1 wherein the receptacle circuit contacts and the mating circuit contacts are arranged in a configuration to allow switching of circuits based on the position of said conduit plate within said receptacle chamber.

7. The mateable shuttle plate connector of claim 1 wherein the receptacle chamber and storage chamber are filled with a pressure-equalizing medium.

8. The mateable shuttle plate connector of claim 1 wherein said storage chamber is formed from an elastomeric pre-molded insulator material.

9. The mateable shuttle plate connector of claim 1 wherein the seal plate covers at least one receptacle circuit contact thereby further protecting it from foreign substances.

10. The mateable shuttle plate connector of claim 2 wherein the positioning means comprises a latching means for the mating half to attach to the sliding seal plate and slide it back into said closed position before unmating.

11. The mateable shuttle plate connector of claim 1 wherein the mating half and the receptacle half are unmated by sliding the sliding sealing plate into said closed position, which in turn pushes the conduit plate back into the mating half.

12. A mateable shuttle plate connector comprising:
a receptacle half;
a receptacle chamber within the receptacle half, filled with a pressure equalizing medium and having a sealed receiving end and a normally closed receiving end;
a mating half, repeatably mateable to the receptacle half;
a storage chamber within the mating half, filled with a pressure equalizing medium, and having a sealed chamber end and a normally closed mating end;
a sliding seal plate in said receptacle chamber connected to a positioning means, wherein said sliding seal plate seals said normally closed receiving end;
at least one contact carrier surface in said receptacle chamber containing at least one receptacle circuit contact on at least one contact carrier surface; and
a conduit plate, contained at least partially within said storage chamber, having at least one mating circuit contact disposed on at least one mating surface, wherein said conduit plate seals said normally closed mating end.

13. A mateable shuttle plate connector for connecting transmission conduits in hostile environments, said connector comprising:
a receptacle half;
a receptacle chamber within the receptacle half, having a normally closed receiving opening;
a mating half, mateable to the receptacle half;
a storage chamber within the mating half, having an normally closed mating opening;
a sliding seal plate in said receptacle chamber, wherein said sliding seal plate seals said normally closed receiving opening when in a closed position;
a positioning means for sliding the sliding seal plate into said closed position;
at least one contact carrier surface in said receptacle chamber containing at least one receptacle circuit contact on at least one contact carrier surface;
a conduit plate, contained at least partially within said storage chamber; and
at least one mating circuit contact disposed on at least one mating surface on said conduit plate.
